(19) United States
(12) Patent Application Publication
(10) Pub. No.: US 2008/0302751 A1
(43) Pub. Date: Dec. 11, 2008

(54) Baby bottle/beverage device

(76) Inventor: Eugenio Segovia, JR., Bellville, TX (US)

Correspondence Address: Kurt S. Myers, 7634 Braesdale Ln., Houston, TX, 77071, US

(21) Appl. No.: 11/811,511

(22) Filed: Jun. 11, 2007

(51) Int. Cl. A61J 9/00; B65D 25/08; B65D 35/22

(52) U.S. Cl. 215/11.3; 206/219; 215/11.1; 222/94

(57) ABSTRACT

The present invention is directed to a unique solid fitment that has a washer/flange that defines its largest diameter, an upper portion of a cylinder structure with a thread on the outside of the cylinder, and a lower portion that provides a sealing neck for a flexible bag. The flex-bag has two compartments. An opening extends throughout the fitment. The upper portion or cylinder structure has a heat seal with a tab to contain the material in the flex-bag. The upper portion is adapted to receive a standard nipple which is held to the cylinder by a compression ring cap.

### FIELD OF THE INVENTION

The present invention is directed to a contemporary baby bottle and/or beverage device. More specifically, the present invention is directed to a fitment/connector that secures a two chamber flex/plastic bag. The flex bag contains solid formula in one chamber and sterile water in the other chamber. The fitment of the present invention is designed so that the two chambers are easily filled on a high speed filling line. The fitment uniquely fits on the lip of a conventional baby bottle or liner and preferably with the addition of clamp rings and a standard nipple creates a product that has substantial shelf life without refrigeration since the formula and water are mixed at a time when the baby is fed.

### BACKGROUND OF THE INVENTION

U.S. Pat. No. 6,612,428 discloses a disposable/recyclable beverage device characterized by a connector that has a circumferential groove around the outer surface of the connector.

U.S. Pat. No. 6,945,394 discloses a disposable/recyclable beverage device characterized by a connector that had threads around the outer surface of the connector.

To the connector in each of the above patents, a two compartment bag is connected to the neck of the connector. To complete the beverage device, a cap that has expansion fingers that snap into the circumferential groove of the connector or a cap that has threads that mesh with the threads around the outer surface of the connector. The designs of the connectors of these two patents require a special cap (30) that is expensive. This cap (30) allows the filled bag and connector to attach to a rigid bottle for easy holding.

In the present invention, a unique fitment/connector overcomes the disadvantages of these prior designs.

### SUMMARY OF THE INVENTION

The present invention is directed to a unique solid fitment that has a washer/flange that defines its largest diameter, an upper portion of a cylinder structure with a thread on the outside of the cylinder, and a lower portion that provides a sealing neck for a flexible bag. The flex-bag has two compartments. An opening extends throughout the fitment. The upper portion or cylinder structure has a heat seal with a tab to contain the material in the flex-bag. The upper portion is adapted to receive a standard nipple which is held to the cylinder by a compression ring cap.

### BRIEF DESCRIPTION OF THE DRAWINGS

FIG. 1 is a perspective view of the fitment with a two compartment filled flex-bag attached to the lower portion of the fitment, and a heat seal and tab closing the upper portion of the fitment of the present invention;

FIG. 1A is a perspective view of the fitment with the flex-bag, with the liquid (water) in the larger compartment at the bottom of the bag and the solid (formula) in the smaller compartment at the top of the bag;

FIG. 2 is a top view of the fitment of the present invention;

FIG. 3 is a side view of the fitment of the present invention;

FIG. 4 is a bottom view of the fitment of the present invention;

FIG. 5 is a side view of the fitment and filled bag as illustrated in FIG. 1 with the solid in the bottom of the bag and the liquid in the top of the bag;

FIG. 5A is a side view of the fitment and filled bag as illustrated in FIG. 1A with the liquid in the bottom of the bag and the solid in the top of the bag;

FIG. 6 is a partial cross-sectional view of the fitment and filled bag with the compartments combined placed in a liner or baby bottle and a nipple attached;

FIG. 6a is an expanded view of the fitment and bag in a liner to illustrate the fitment in the environment for feeding a baby.

### DESCRIPTION OF THE PREFERRED EMBODIMENTS

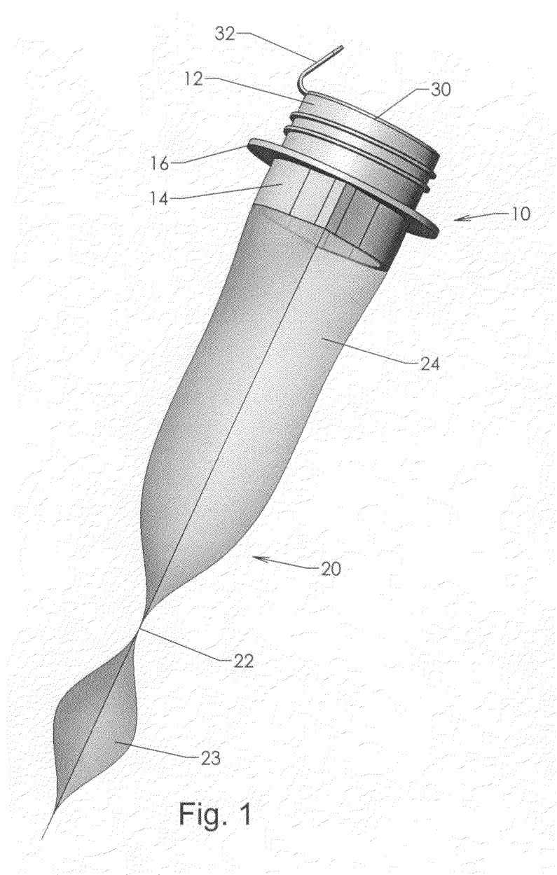

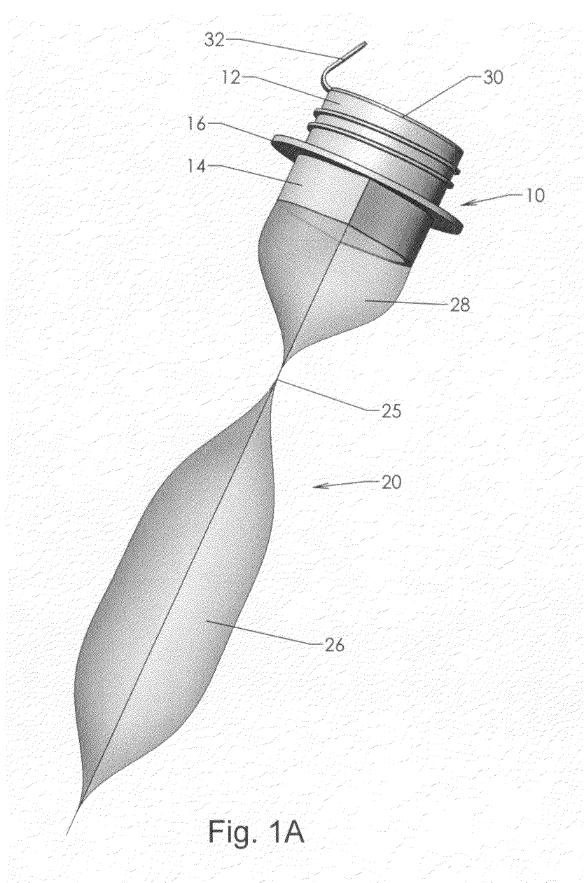

Referring now to FIG. 1, a fitment 10, that preferably is a single extruded plastic piece, has an upper portion 12 and a lower portion 14. Between upper portion 12 and lower portion 14 is a flange/washer portion 16 of greater diameter than the upper portion and the lower portion. An opening 18 extends through each of the upper 12, lower 14 and flange/washer 16 portions.

By having a simple fitment that may be used in a high speed filling machine, a low cost disposable beverage device is possible. The lower portion 14 is placed into the opening of a flex-bag 20 and a tool seals a flex-bag to the fitment. The flex-bag 20 may be first filled with a solid (preferably baby formula), then the flex-bag 20 sealed at 22 to form a first compartment 23. Into the second compartment 24, a liquid (preferably water) is introduced. After both compartments 23 and 24 are filled, a heat seal 30 is applied to the top of the upper portion 12 of fitment 10. Heat seal 30 has a tab 32 for easy removal of the seal 30.

The foregoing, FIG. 1, represents one embodiment of a product of the present invention.

Now referring to FIG. 1A, the fitment 10 is the same as above; however, the filling operations are changed. In these embodiments, the flex-bag 20 is first filled with a liquid, then the flex-bag 20 sealed at 25 to form a first compartment 26. Into the second compartment 28, a solid may be introduced. Alternatively the second compartment may be left empty in the high speed filling operation. In either case, a heat seal 30 having a tab 32 is applied to the top of the upper portion 12 of fitment 10. The choice of filling operations is left to the marketer and the nature of the solids used.

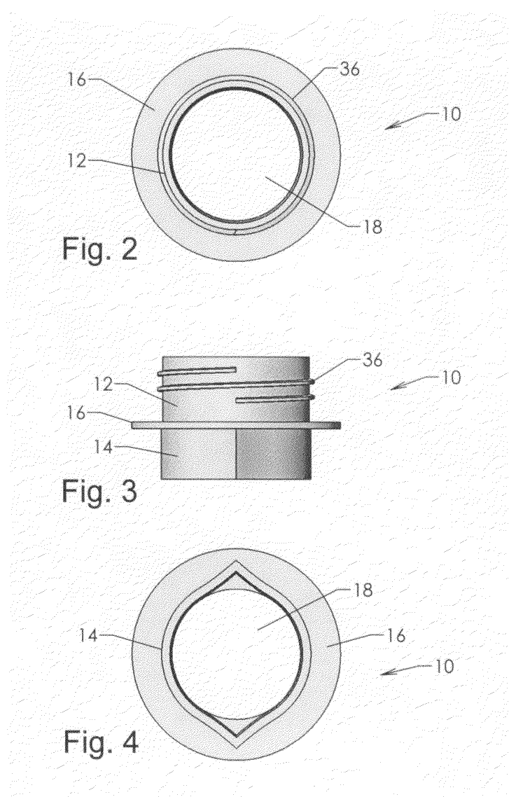

The preferred characteristics of fitment 10 are illustrated in FIG. 2 (top view), FIG. 3 (side view) and FIG. 4 (bottom view):

In FIG. 2, the upper portion 12 and flange/washer portion 16 of fitment 10 are shown. Around the outside cylindrical portion 12 are threads 36.

In FIG. 3, the upper portion 12, the lower portion 14 and the flange/washer portion 16 of fitment 10 are shown. Around the outside cylindrical portion 12 are threads 36. The lower portion 14 may have different designs than that shown. For example, the lower portion 14 may be tapered, i.e. the diameter of the lower portion is greater at the interface with the flange/washer portion 16 of fitment 10 than the terminal end of portion 14.

In FIG. 4, the lower portion 14 and flange/washer portion 16 of fitment 10 are shown. The preferred design will easily fit into the open end of a flex-bag 20 and with a tool will heat seal the bag to the lower portion 14 of fitment 10.

As shown in the FIGS. 2, 3 and 4, an opening 18 extends through each of the upper 12, lower 14 and flange/washer 16 portions of fitment 10.

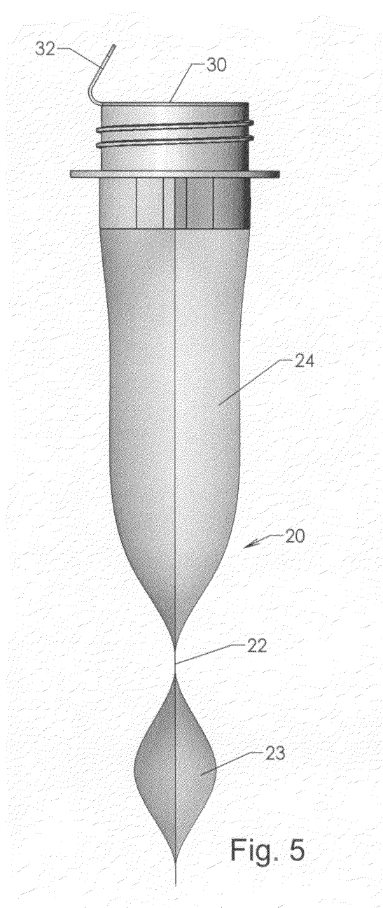

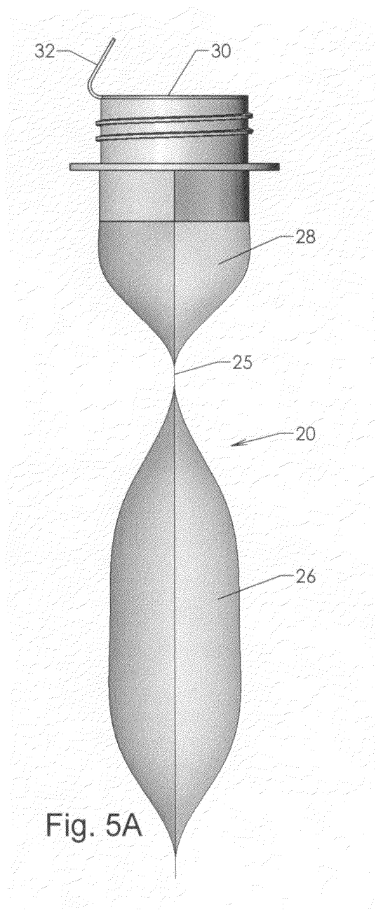

FIG. 5 and FIG. 5A are shown to draw attention of the nature of seals 22 and 25. Also, the uniqueness of the alternate filling operation of the embodiment of FIG. 5A is emphasized. When the upper portion 28 is left empty of a solid (usually baby formula), the mother has the option to fill the upper compartment with a formula of choice or a juice concentrate and has complete control over the amount of solid added for a given volume of water. This option has an advantage for new babies that have not settled on a formula of choice. The seals 22 and 25 transverse the flex-bag 20 and are sufficiently strong to maintain the separation of the solid and liquid in the two chambers, but when it is desired to mix the solid and liquid, the flex-bag 20 is squeezed causing internal seam 22 or 25 to break or rupture.

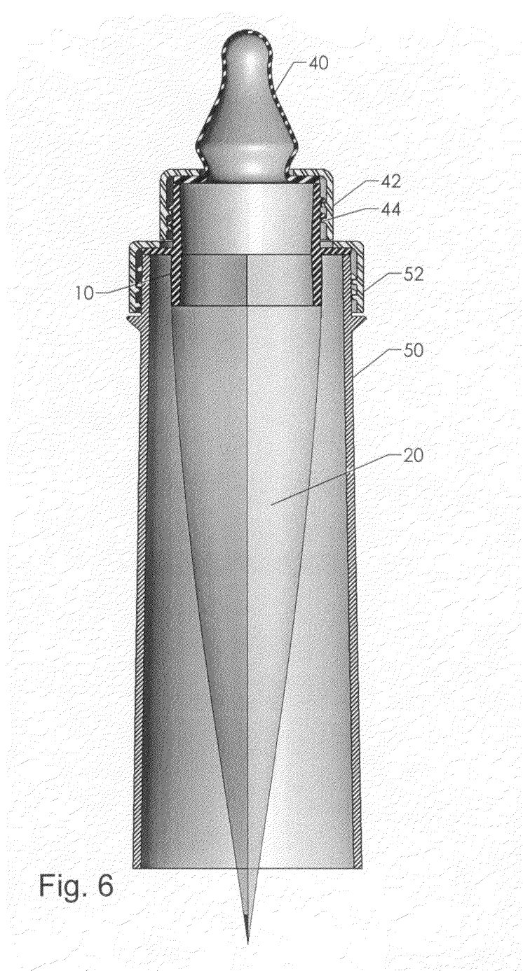

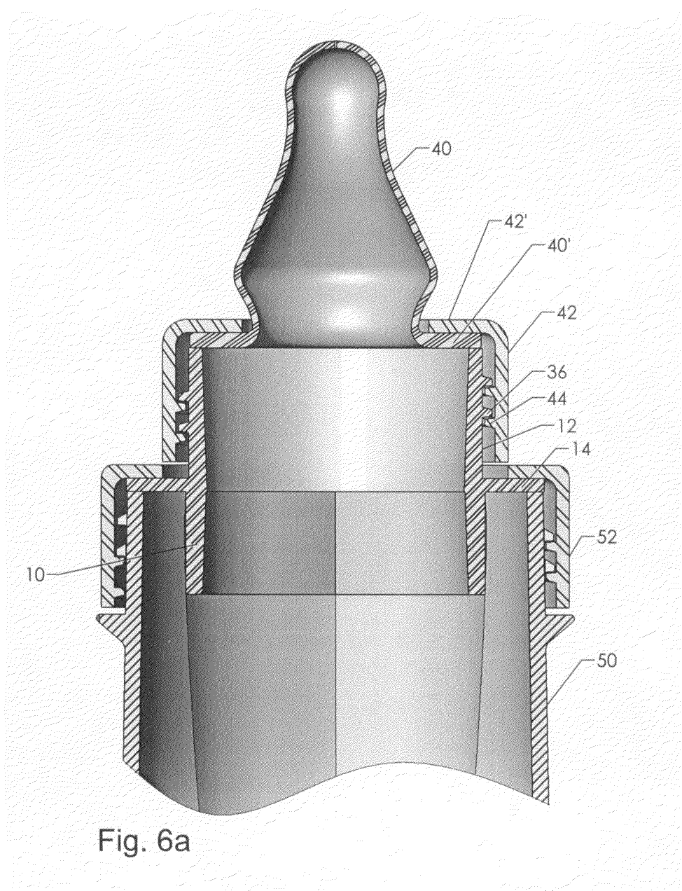

The advantage of the fitment and the sealed two compartment flex-bag is that the shelf life of the non-mixed solid and liquid is extendable over days, months or even years and does not require refrigeration. This contrasts with conventional mixing of baby formula and water that when mixed requires immediate consumption or refrigeration. Further, the flex-bag always has clean, sterile water in one compartment and therefore does not need a source of clean water such as when traveling. After breaking seal 22 or 25, all that is necessary for feeding a baby is a nipple. The heat seal 30 is removed by pulling on tab 32, and by having a nipple 40 and a nipple compression ring 42 available, the nipple 40 is compressed and seated on the top of the upper portion 12 of fitment 10 by ring 42, as shown in FIGS. 6 and 6a.

Referring now to FIGS. 6 and 6a, these figures represent the fitment 10 with the flex-bag 20 having seal 22 or 25 broken to permit the mixing of the solid and liquid, and the heat seal 30 removed. In place of the seal 30, a nipple 40 is compressed and seated on the top of the upper portion 12 of fitment 10 by ring 42. The threads 44 of ring 42 align with the threads 36 on the outside surface of upper portion 12 of fitment 10. Upon screwing ring 42 onto the fitment 10 the ring surface 42′ compresses and seats the lower lip 40′ of the nipple 40 on the top of the upper portion 12 of fitment 10. In many instances, this combination of fitment 10 with a filled flex-bag 20 and a nipple 40 is sufficient for the feeding of the baby.

However, if the mother feels more comfortable with a larger solid structure to hold, fitment 10 is designed to fit into a conventional liner bottle 50 (or baby bottle). With the screw ring 52, which normally holds a nipple to the top of the liner, ring 52 compresses the flange/washer portion 16 of fitment 10 to the top of the liner 50.

1. A baby beverage device comprising:
a solid fitment, said fitment having an upper portion and a lower portion, between said upper portion and lower portion is a flange/washer portion of greater diameter than said upper portion and lower portion, and an opening extending through said lower, upper and flange/washer portions, said lower portion adapted to connect and hold a flex bag; and
a two compartment flex bag connected to said lower portion of said fitment.

2. A device according to claim 1 wherein a breakable sealed seam forms said two compartments.

3. A device according to claim 2 wherein one compartment of said bag contains a solid and the other compartment contains a liquid.

4. A beverage dispenser comprising:
a solid fitment, said fitment having an upper portion and a lower portion, between said upper portion and lower portion is a flange/washer portion of greater diameter than said upper portion and lower portion, said diameter adapted to fit on the lip of a baby/liner bottle and an opening extending through said lower, upper and flange/washer portions, said lower portion adapted to connect and hold a flex bag; and
a two compartment flex bag connected to said lower portion of said fitment.
